(19) United States
(12) Patent Application Publication
(10) Pub. No.: US 2024/0416629 A1
(43) Pub. Date: Dec. 19, 2024

(54) MULTILAYER POLYMER STRUCTURE AND MANUFACTURING METHOD THEREOF

(71) Applicant: NAN YA PLASTICS CORPORATION, TAIPEI (TW)

(72) Inventors: Te-Chao Liao, TAIPEI (TW); Chun-Che Tsao, TAIPEI (TW); Wen-Jui Cheng, TAIPEI (TW); Yueh-Shin Liu, TAIPEI (TW)

(73) Assignee: NAN YA PLASTICS CORPORATION, TAIPEI (TW)

(21) Appl. No.: 18/471,321

(22) Filed: Sep. 21, 2023

Related U.S. Application Data
(63) Continuation-in-part of application No. 18/354,673, filed on Jul. 19, 2023, now abandoned.

(30) Foreign Application Priority Data
Jun. 14, 2023 (TW) 112122113
Sep. 14, 2023 (TW) 112134992

(51) Int. Cl. B32B 27/08; B32B 7/02; B32B 27/36

(52) U.S. Cl. CPC B32B 27/08; B32B 7/02; B32B 27/36; B29C 48/21; B29K 2067/003; B29K 2995/0039; B32B 2250/03; B32B 2250/244; B32B 2272/00; B32B 2307/31; B32B 2307/54; B32B 2307/558; B32B 2307/702; B32B 2307/7376

(57) ABSTRACT

A multilayer polymer structure includes a supporting layer and a first surface layer. The supporting layer includes polyethylene terephthalate. The supporting layer has a melting point of 235 to 252 degrees Celsius. The first surface layer is located on a first surface of the support layer and includes amorphous polyethylene terephthalate.

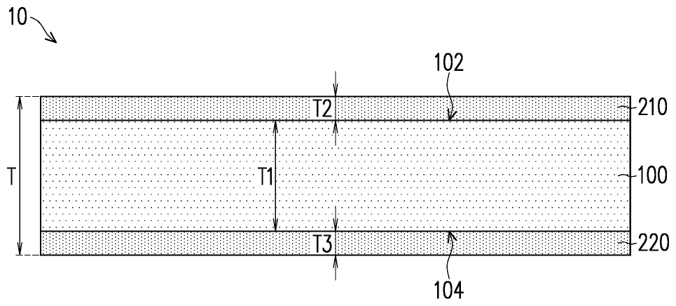

### CROSS-REFERENCE TO RELATED APPLICATION

This application is a continuation-in-part application of U.S. patent application Ser. No. 18/354,673, filed on Jul. 19, 2023, which claims the priority benefit of Taiwan application serial no. 112122113, filed on Jun. 14, 2023. This application also claims the priority benefit of Taiwan application serial no. 112134992, filed on Sep. 14, 2023. The entirety of each of the above-mentioned patent applications is hereby incorporated by reference herein and made a part of this specification.

### BACKGROUND

### Technical Field

The invention relates to a multilayer polymer structure and a manufacturing method thereof.

### Description of Related Art

In response to increasing awareness of environmental protection, the recycling of plastic products has garnered growing attention. Currently, many electronic products on the market are packaged using cardboard and transparent plastic casings adhered to the cardboard. This allows consumers to directly view the electronic products enclosed within through the transparent plastic casings. In general, the material of these transparent plastic casings is a co-extruded material of polyethylene terephthalate (PET) and Poly (ethylene terephthalateco-1,4-cylclohexylenedimethylene terephthalate) (PETG). It consists of PET as the intermediate support layer and PETG as the surface adhesive layer. Although PETG and PET are both polyester materials, PETG is classified with a resin identification code of 7, while PET is classified with a resin identification code of 1. This makes it challenging to recycle PETG and PET together. Therefore, there is an urgent need for a method that can improve the recyclability of packaging materials.

### SUMMARY

At least one embodiment of the present invention provides a multilayer polymer structure, which includes a supporting layer and a first surface layer. The supporting layer includes polyethylene terephthalate. The supporting layer has a melting point of 235 degrees Celsius to 252 degrees Celsius. The first surface layer is located on a first surface of the supporting layer, and the first surface layer includes amorphous polyethylene terephthalate.

At least one embodiment of the present invention provides a method for manufacturing a multilayer polymer structure, including the following steps. First polyester pellets are provided, wherein the first polyester pellets include polyethylene terephthalate, and the first polyester pellets have a melting point of 235 degrees Celsius to 252 degrees Celsius. Second polyester pellets are provided, wherein the second polyester pellets include amorphous polyethylene terephthalate. A supporting layer and a first surface layer on a first surface of the supporting layer are formed by co-extrusion, wherein a raw material of the supporting layer includes the first polyester pellets, and the a material of the first surface layer includes the second polyester pellets.

### BRIEF DESCRIPTION OF THE DRAWINGS

FIGURE is a schematic cross-sectional view of a multilayer polymer structure according to an embodiment of the present invention.

### DESCRIPTION OF THE EMBODIMENTS

FIGURE is a schematic cross-sectional view of a multilayer polymer structure according to an embodiment of the present invention. Referring to the FIGURE, the multilayer polymer structure 10 includes a supporting layer 100 and a first surface layer 210 located on the first surface 102 of the supporting layer 100. In this embodiment, the multilayer polymer structure 10 further includes a second surface layer 220 located on the second surface 104 of the supporting layer 100.

The supporting layer 100 includes polyethylene terephthalate (PET). In some embodiments, the polyethylene terephthalate in the supporting layer 100 may include virgin polyester, recycled polyester, or a combination thereof. Virgin polyester refers to newly produced polyester, while recycled polyester may include physically recycled polyester and/or chemically recycled polyester. In some embodiments, virgin polyester and/or recycled polyester are used as raw materials to manufacture polyester pellets, which are then used as raw materials to form the supporting layer 100.

For example, methods of obtaining recycled polyester include collecting various types of waste polyester resin materials. The collected waste polyester resin materials are then classified based on their type, color, and usage. Subsequently, the waste polyester resin materials are compressed and packaged, and then being transported to waste treatment facilities.

In some embodiments, the waste polyester resin materials include recycled PET bottles, film materials, fibers, etc., but the present invention is not limited to these. Other components on the waste polyester resin materials, such as bottle caps, labels, and adhesives, are removed. Subsequently, the waste polyester resin materials are cut, crushed, and separated using methods like flotation to separate the bottle necks, liners, and bodies made of different materials within PET bottles. The crushed waste polyester resin materials are then dried to obtain processed recycled polyester material (i.e., recycled polyethylene terephthalate (r-PET)) for subsequent manufacturing processes.

The recycled polyester material is further processed to obtain recycled polyester pellets. The recycled polyester pellets may be physically recycled polyester pellets or chemically recycled polyester pellets.

In some embodiments, physically recycled polyester pellets refer to polyester resins that are fabricated through physical recycling methods which include physically recycled conventional polyester pellets and physically recycled modified polyester pellets. Physically recycled conventional polyester pellets do not incorporate any functional additives during the recycling process. However, physically recycled modified polyester pellets involve the addition of functional additives (such as lubricants, colorants, weathering agent, and matting agents) during the recycling process to produce physically recycled modified polyester pellets with different functionalities.

In some embodiments, the manufacturing process of chemically recycled polyester pellets includes the following steps: cutting recycled polyester materials (such as PET bottle flakes) and placing the cut flakes into a chemical depolymerization solution. This causes the polyester molecules in the recycled polyester materials to break down, achieving depolymerization of the recycled polyester materials. Furthermore, it is possible to obtain polyester compositions with shorter polymer chains and ester monomers composed of one diacid unit and two diol units, such as bis(2-hydroxyethyl) terephthalate (BHET). Then, the oligomer mixture is then separated and purified, followed by re-polymerization of the oligomer mixture to produce chemically recycled polyester pellets. In some embodiments, functional additives (such as lubricants, colorants, weathering modifiers, and matting agents) can be added to the oligomer mixture during the chemical remanufacturing process. Subsequently, polymerization is carried out to obtain chemically recycled modified polyester pellets with different functionalities.

The polyethylene terephthalate in the supporting layer 100 is crystalline, so it has a melting point of 235 degrees Celsius to 252 degrees Celsius. In some embodiments, the polyethylene terephthalate in the supporting layer 100 has a crystallinity of more than 9% at room temperature (about 23° C.). In some embodiments, the cooling crystallization temperature (Tcc) of the polyethylene terephthalate in the supporting layer 100 is 160° C. to 190° C.

The polyethylene terephthalate in the supporting layer 100 has an intrinsic viscosity (IV) ranging from 0.72 dL/g to 0.84 dL/g, with a preferable range between 0.76 dL/g to 0.80 dL/g. When the intrinsic viscosity falls below 0.72, the viscosity of the material is too low, resulting in poor extrusion sheet formation and reduced impact strength. When the intrinsic viscosity exceeds 0.84, the viscosity of the material is too high, leading to a decrease in sheet production speed by more than 20%, along with a higher energy demand for processing temperatures. In some embodiments, the intrinsic viscosity of polyethylene terephthalate can be increased through a viscosity-enhancing process, which includes solid viscosity-increasing method and/or liquid viscosity-increasing method.

The first surface layer 210 and the second surface layer 220 are respectively located on the first surface 102 and the second surface 104 of the supporting layer 110. The first surface layer 210 and the second surface layer 220 include amorphous polyethylene terephthalate (amorphous PET). In some embodiments, the first surface layer 210 and the second surface layer 220 are formed by using amorphous polyethylene terephthalate polyester pellets as raw materials.

In some embodiments, transesterification is performed between terephthalic acid (PTA) and ethylene glycol (EG) to form bis(2-hydroxyethyl) terephthalate (BHET). Subsequently, BHET is co-polymerized with monomers having steric hindrance to form amorphous polyethylene terephthalate. In some embodiments, the amorphous polyethylene terephthalate includes 18 mol % to 35 mol % of the monomers with steric hindrance. In some embodiments, the monomers with steric hindrance are selected from at least one of the following combinations: isophthalic acid, neopentyl glycol, phthalic acid, pentaerythritol, propylene glycol, isosorbide and polyethylene glycol. By adjusting the content of the monomers with steric hindrance, the crystallization rate of polyethylene terephthalate can be delayed, facilitating the preparation of the amorphous polyethylene terephthalate. In some embodiments, the amorphous polyethylene terephthalate in the first surface layer 210 and the second surface layer 220 is amorphous (without a melting point) material and exhibits a softening phenomenon when the temperature exceeds its glass transition temperature, making it suitable for use as an adhesive layer. In some embodiments, the glass transition temperature of the amorphous polyethylene terephthalate in the first surface layer 210 and the second surface layer 220 is between 60° C. and 80° C., and the amorphous polyethylene terephthalate doesn't have a melting point and a cooling crystallization temperature (Tcc).

The aforementioned amorphous polyethylene terephthalate material was cut and granulated to obtain polyester pellets of amorphous polyethylene terephthalate. In some embodiments, the granulation is carried out by a screw extruder granulator, so that the aforementioned amorphous polyethylene terephthalate material is made into granulated polyester pellets.

Finally, co-extrusion is carried out using polyester pellets of polyethylene terephthalate and polyester pellets of amorphous polyethylene terephthalate as raw materials to form the supporting layer 100, the first surface layer 210 and the second surface layer 220. The raw material of the supporting layer 100 includes polyester pellets made of polyethylene terephthalate (also called first polyester pellets), and the raw materials of the first surface layer 210 and the second surface layer 220 include amorphous polyester pellets of amorphous ethylene terephthalate (also called second polyester pellets). The first polyester pellets and the second polyester pellets are put into the extruder respectively, and the multilayer polymer structure 10 is produced by the co-extrusion process.

In some embodiments, the thickness T of the multilayer polymer structure 10 is 0.15 mm to 1.4 mm. In some embodiments, the thickness T1 of the supporting layer 100 occupies 70% to 88% of the thickness T of the multilayer polymer structure 10, and the thickness T2 of the first surface layer 210 and the thickness T3 of the second surface layer 220 respectively occupy 6% to 15% of the thickness T of the multilayer polymer structure 10.

In some embodiments, after performing the co-extrusion process, the obtained multilayer polymer structure 10 is cooled, for example, by a cooling wheel. Then the cooled multilayer polymer structure 10 is rolled up, and finally the forming and heat-sealing process (such as high-frequency heat sealing, thermal lamination, etc.) is carried out according to the requirements. In this embodiment, the softening temperature (or glass transition temperature) of the first surface layer 210 and the second surface layer 220 in the multilayer polymer structure 10 is lower than that of the supporting layer 100. As a result, when heated, the first surface layer 210 and the second surface layer 220 readily soften, enabling them to function as adhesive layers for bonding other components.

Table 1 presents a comparison between the composition and physical properties of amorphous polyethylene terephthalate with various steric hindrance monomers, as found in some examples, and the physical properties of PETG.

TABLE 1

| | Example 1 | Example 2 | Example 3 | PETG |
|---|---|---|---|---|
| monomers | Isophthalic | Isophthalic | Isophthalic | 1,4- |
| with steric | acid | acid (10 | acid (12 | Cyclohex- |
| hindrance | | mol %) + | mol %) + | anedimethanol |
| | | Neopentyl | Neopentyl | |
| | | glycol (10 | glycol (8 | |
| | | mol %) | mol %) | |
| Content of | 20 | 20 | 20 | 35 |
| monomers | | | | |
| with steric | | | | |
| hindrance | | | | |
| (mol %) | | | | |
| Intrinsic | 0.66 | 0.68 | 0.65 | 0.74 |
| viscosity | | | | |
| Tensile | 60 | 52 | 48 | 46 |
| strength at | | | | |
| 23° C. | | | | |
| (MPa) | | | | |
| glass | 68 | 67 | 76 | 70 |
| transition | | | | |
| temperature | | | | |
| (° C.) | | | | |

In table 1, no additional viscosity-increasing processes were applied to the amorphous polyethylene terephthalate in Examples 1 to 3. Additionally, the intrinsic viscosity of the amorphous polyethylene terephthalate is lower than the intrinsic viscosity range suitable for the polyethylene terephthalate used in the supporting layer (0.72 dL/g to 0.84 dL/g). Table 2 provides a comparison of the characteristics of multilayer polymer structures between some examples and some comparative examples. The multilayer polymer structures in Table 2 consist of two surface layers and a supporting layer sandwiched between the surface layers.

TABLE 2

| | Comparative | Comparative | | | |
|---|---|---|---|---|---|
| | example 1 | example 2 | Example 4 | Example 5 | Example 6 |
| surface layers | PETG | Virgin PET | Amorphous | Amorphous | Amorphous |
| | | | polyethylene | polyethylene | polyethylene |
| | | | terephthalate | terephthalate | terephthalate |
| | | | material | material | material |
| | | | modified by | modified by | modified by |
| | | | copolymerization | copolymerization | copolymerization |
| | | | of isophthalic | of isophthalic | of isophthalic |
| | | | acid (10 mol %) + | acid (10 mol %) + | acid (10 mol %) + |
| | | | neopentyl glycol | neopentyl glycol | neopentyl glycol |
| | | | (10 mol %) | (10 mol %) | (10 mol %) |
| supporting | Virgin PET | Virgin PET | Virgin PET | 80 wt % Virgin | 50 wt % Virgin |
| layer | | | | PET + 20 wt % r- | PET + 50 wt % r- |
| | | | | PET | PET |
| The adhesive | Adhesive | Adhesive | Adhesive | Adhesive | Adhesive |
| properties of | successfully | failure | successfully | successfully | successfully |
| the 100° C. to | | | | | |
| 120° C. heat | | | | | |
| sealing process | | | | | |
| Impact | 3.73 | 2.16 | 3.87 | 3.79 | 3.70 |
| resistance after | | | | | |
| heat sealing | | | | | |
| process at | | | | | |
| 100° C. to 120° C. | | | | | |
| (KJ/m) | | | | | |
| The drop ball | no rupture | rupture | no rupture | no rupture | no rupture |
| impact test | | | | | |
| after the 100° C. | | | | | |
| to 120° C. heat | | | | | |
| sealing process | | | | | |

According to table 2, it can be observed that the characteristics of the multilayer polymer structures using amorphous polyethylene terephthalate (APET) as the surface layers, after undergoing heat sealing processes such as high-frequency heat sealing or thermal lamination, are similar to the characteristics of PETG. Furthermore, the multilayer polymer structures in examples 4 and 5 exhibit higher impact resistance compared to the comparative example 1, where PETG is used as the surface layers. Additionally, the multilayer polymer structures in examples 4 to 6 exhibited no rupture in the drop ball impact test, making them suitable for use as packaging material, card, and other packaging component of products such as electronic devices. Moreover, since both amorphous polyethylene terephthalate and PET are classified under plastic resin identification code #1, the multilayer polymer structures obtained by using amorphous polyethylene terephthalate as the surface layers and PET as the supporting layer can be easily recycled, thus offering energy-saving. carbon-reducing. and environmentally friendly advantages.

What is claimed is:

1. A multilayer polymer structure, comprising:
a supporting layer comprising polyethylene terephthalate, and the supporting layer has a melting point of 235 degrees Celsius to 252 degrees Celsius; and
a first surface layer located on a first surface of the supporting layer, wherein the first surface layer comprises amorphous polyethylene terephthalate.

2. The multilayer polymer structure of claim 1, wherein the first surface layer comprises 18 mol % to 35 mol % of monomers with steric hindrance.

3. The multilayer polymer structure of claim 2, wherein the monomers with steric hindrance are selected from at least one of the following combinations: isophthalic acid, neopentyl glycol, phthalic acid, pentaerythritol, propylene glycol, isosorbide and polyethylene glycol.

4. The multilayer polymer structure of claim 1, further comprising:
a second surface layer located on a second surface of the supporting layer opposite to the first surface, and the second surface layer includes the amorphous polyethylene terephthalate.

5. The multilayer polymer structure of claim 4, wherein a thickness of the supporting layer occupies 70% to 88% of a thickness of the multilayer polymer structure, and a thickness of the first surface layer and a thickness of the second surface layer respectively occupy 6% to 15% of the thickness of the multilayer polymer structure.

6. A method of manufacturing a multilayer polymer structure, comprising:
providing first polyester pellets, wherein the first polyester pellets comprise polyethylene terephthalate, and the first polyester pellets have a melting point of 235 degrees Celsius to 252 degrees Celsius;
providing second polyester pellets, wherein the second polyester pellets comprise amorphous polyethylene terephthalate;
forming a supporting layer and a first surface layer located on a first surface of the supporting layer by co-extrusion, wherein a raw material of the supporting layer comprises the first polyester pellets, and a raw material of the first surface layer comprises the second polyester pellets.

7. The method of claim 6, wherein a method of providing the second polyester pellets comprises:
performing a transesterification between terephthalic acid and ethylene glycol to form bis(2-hydroxyethyl) terephthalate;
the bis(2-hydroxyethyl) terephthalate is copolymerized with monomers with steric hindrance to form the second polyester pellets comprising the amorphous polyethylene terephthalate.

8. The method of claim 7, wherein the amorphous polyethylene terephthalate comprises 18 mol % to 35 mol % of the monomers with steric hindrance.

9. The method of claim 8, wherein the monomers with steric hindrance are selected from at least one of the following combinations: isophthalic acid, neopentyl glycol, phthalic acid, pentaerythritol, propylene glycol, isosorbide and polyethylene glycol.

10. The method of claim 6, further comprising:
forming the supporting layer, the first surface layer located on the first surface of the supporting layer, and a second surface layer located on a second surface of the supporting layer opposite to the first surface by co-extrusion, wherein a raw material of the second surface layer comprises the second polyester pellets.
